(19) United States
(12) Patent Application Publication
(10) Pub. No.: US 2010/0051847 A1
(43) Pub. Date: Mar. 4, 2010

(54) Method and Apparatus for Severing Conduits

(75) Inventors: Jason C. Mailand, The Woodlands, TX (US); Thomas G. Hill, JR., Conroe, TX (US)

Correspondence Address: BURLESON COOKE L.L.P., 2040 NORTH LOOP 336 WEST, SUITE 123, CONROE, TX, 77304, US

(73) Assignee: Tejas Research and Engineering, LP, The Woodlands, TX (US)

(21) Appl. No.: 12/204,002

(22) Filed: Sep. 4, 2008

(51) Int. Cl. F16K 51/00; E21B 29/00

(52) U.S. Cl. 251/288; 166/55

(57) ABSTRACT

Apparatus is provided for cutting a conduit passing through a valve as the valve is closed. The apparatus may be used in subsea well operations or as a safety valve in any well. A spherical outside surface on a cutter element seats in the apparatus. The cutter element cuts a conduit passing through the apparatus in one location and leaves free the severed pieces of the conduit. An actuator to rotate the cutter element may be driven by energy stored in springs or by hydraulic pressure.

### BACKGROUND OF THE INVENTION

1. Field of the Invention

The present invention relates generally to safety shut-in valves and systems in subsea wells. More particularly, it relates to method and device for cutting conduits, such as cables or tubing in advance of shutting valves preparatory to disconnecting from a subsea well, before closing a downhole safety valve for well control or for other conditions when a conduit extends through the valve and the valve must be closed.

2. Description of Related Art

Offshore wells frequently are completed with wellheads at the seafloor. While this may significantly reduce the cost of completing a well in deeper water, it has made well monitoring and interventions more complicated and difficult. For an intervention into a subsea well, a blowout preventer stack is normally run on a marine riser and attached to the wellhead. The marine riser provides a path for fluid communication with the well and for tools to be run into the well. The tools may be lowered by electric wireline, slickline, coiled tubing or jointed tubing, all of which will be referred to herein as conduit.

A surface vessel used in the intervention must be maintained in proper position relative to the well, with only limited tolerance for deviation. Current and weather conditions, as well as positioning system failures, can bring the surface vessel out of position. If the vessel strays beyond the tolerances of the system, the connection of the riser to the well must be disconnected quickly to prevent damage to the wellhead or other equipment. If there are tools in the well attached to conduits, the conduits must be severed before disconnection of the riser. This leads to a need for quick and effective severing tools. FIG. 1 illustrates intervention in subsea well 10 using coiled tubing from boat 12, with support boat 14. Workover riser 16 has been equipped with conduit cutter 17, which may be powered by boat 14. Tool 18, supported by coil tubing 19, is being lowered into well 10, as shown through a cutaway in the drawing. The disclosure herein relates to various embodiments of severing tool 17.

Systems used for flowing and testing subsea wells typically include safety shut-in and disconnect systems that automatically stop fluid communication between the well and surface vessel in the event of an emergency. These systems are commonly part of a subsea test tree that is positioned inside the blowout preventer stack, as illustrated in FIG. 2A. Well 20 has blowout preventer stack 22. Riser 24 is connected to the well, having riser connector component 24a, which is adapted to latch on to and quickly release from component 24b. Subsea test tree 26 often includes one or more safety valves 28 that can shut-in both well 20 and riser 24 before disconnecting 24a and 24b. Tools such as tool 29 are usually run through the test tree and into the well on a conduit such as conduit 25. In an emergency, there may be a need to shut-in the well and riser very quickly, without time for retrieving tools. In such a case, conduit 25 must be quickly severed, before riser 24 is disconnected. FIG. 2B illustrates a disconnected riser and conduit in well 20. Conduit 25 has been severed, safety valves 28 have closed and riser disconnect 24a and 24b have been operated. Part of conduit 25 and tool 29 have been left in well 20 to be retrieved later.

Subsea wells and most land wells have a subsurface safety valve in the tubing that is designed to close flow from the well in case of surface damage to the well. This valve may be held open by hydraulic pressure applied from the surface and closed by stored energy, such as in a spring. Alternatively, the valve may be closed by hydraulic pressure from the surface. Shutting flow from a well may also be necessary before or during well completion, production logging, or other interventions or workovers. Leaks or other emergencies may make it necessary to close a well quickly. If there is a conduit through a valve that is to be closed without taking time to retrieve the conduit, a cutter valve element is needed.

Currently, a conduit is normally cut by closing a ball valve, which may shear the conduit. Ball valves are well known and have been used in various applications for many years. The valve element is ball-shaped and has a cylindrical flow-passage bored through its center. Rotating the ball moves the flow-passage into or out of alignment with the conduit in which it is installed, opening and closing the valve. Because of its design, a ball valve must shear the conduit at two locations simultaneously—i.e., on each side of the flow-passage. This doubles the amount of force that must be applied to the valve to achieve closure. This problem is compounded as the conduits that must be sheared become larger. Also, burrs from the severed line may become entrapped between the ball and housing, causing damage to sealing surfaces and increasing the likelihood of leakage around the valve. Some systems for coiled tubing use cutters disposed on either side of the tubing, which are more reliable, but such systems require considerable space.

U.S. Pat. No. 5,873,415 discloses a completion subsea test tree system having ball valves that may be actuated for cutting coiled tubing in case of an emergency requiring disconnecting from a subsea well.

U.S. Pat. No. 7,086,467 discloses a system for cutting a conduit such as coiled tubing with a piston and shear blade attached to the piston. The valve assembly may include a flapper valve and a ball valve. The system may be located below a safety valve in a well.

There exists a need in industry for a system that reliably and quickly severs conduits in well systems to enable a valve to be closed. There is also a need for a system that is not prone to damage from the cutting process.

### SUMMARY OF INVENTION

The disclosed system cuts conduit by providing a valve with a cutter edge that engages and severs the line on only one side of the valve, while requiring no more space than a traditional ball valve. The disclosed system may use a valve element having a spherical surface with a flow-passage of non-uniform dimension—i.e., with one end larger than the other. Alternatively, the valve may comprise a valve element having a spherical surface with an open channel on one side of the element.

### BRIEF DESCRIPTION OF THE DRAWINGS

FIG. 1 is a sketch of a subsea well during an intervention in the well using coiled tubing.

FIG. 2A is a sketch of a subsea well during testing of the well through a test tree and a riser with a tool in the well. FIG. 2B is a sketch of the well after disconnection of the riser from the well.

FIG. 3A is a cross-section view of one embodiment of a cutter on a valve element disclosed herein showing the cutting of a conduit in one location. FIG. 3B shows the valve element in the sealing or closed configuration.

FIGS. 4A, 4B and 4C are isometric views of one embodiment of the valve element shown in FIG. 3.

FIGS. 5A, 5B and 5C are isometric views of another embodiment of a cutter valve element disclosed herein.

FIG. 6A is an isometric view of a hydraulic and spring-driven rack and pinion mechanism that may be used as an actuator for a cutter valve element, showing the valve element of FIG. 5 in the open position. FIG. 6B is an isometric view of a hydraulic and spring-driven rack and pinion mechanism that may be used as an actuator for a cutter valve element, showing the valve element of FIG. 5 in the closed position.

FIG. 7A is a cross-section view of the hydraulic pressure-spring driven mechanism of FIG. 6 in an assembly where release of pressure cuts a conduit using a cutter on a valve element, showing the valve in the open position. FIG. 7B is a cross-section view of the hydraulic pressure-spring driven mechanism of FIG. 6 in an assembly where release of pressure cuts a conduit using a cutter on a valve element, showing the valve in the closed position.

### DETAILED DESCRIPTION

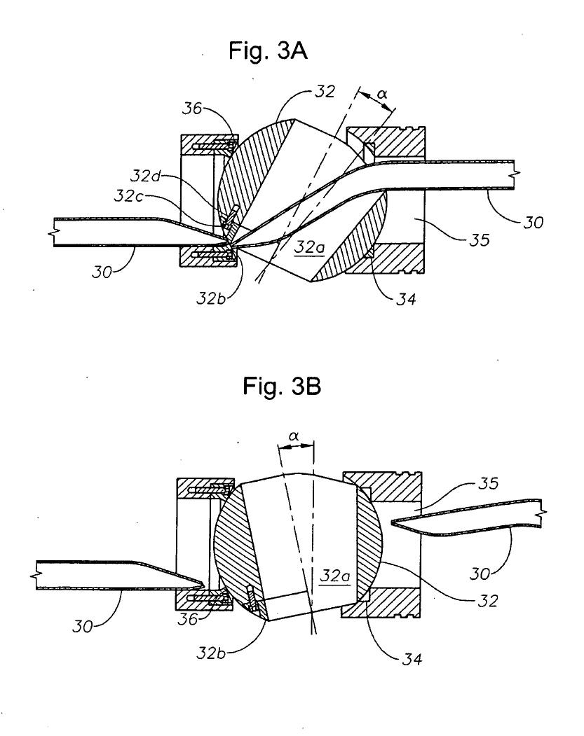

Referring to FIG. 3A, conduit 30 is being severed by cutting valve element 32 as the cutting element rotates around its axis of rotation. After conduit 30 is severed and is displaced from valve element 32 by gravity or pull, valve element 32 may seal on valve seats 34 and 36, so as to prevent flow in valve body passage 35, as shown in FIG. 3B. Valve element 32 has a spherical outside surface and element channel 32a therethrough. Valve element channel 32a is preferably formed such that when cutting edge 32b has severed conduit 30, the opposite end of channel 32a from edge 32b is not restricting movement of conduit 30. Cutting edge 32b may be formed by valve element 32 or may be formed by replaceable segment 32c, made of the same material as valve element 32 or made of a special cutting material, such as a hard metal alloy or ceramic. Segment 32c may be replaced using set screws 32d. Valve element channel 32a may be formed by drilling intersecting holes, preferably of equal diameter, through valve element 32. The centerlines of two openings intersecting at angle α are shown passing through channel 32a. Angle α is selected according to the size of conduit 30 and the diameter of valve seats 34 and 36. Preferably, angle α is also selected such that when valve element 32 is closed the spherical surface of element 32 is seated on both valve seats 34 and 36. Alternatively, valve element 32 may seat only on either valve seat 34 or valve seat 36. For example, if conduit 30 has a diameter of 2 inches, valve seats 34 and 36 have an inside diameter of about 7.5 inches], it is desired that both pieces of conduit 30 be free to move after severing and it is desired that valve element 32 seat on both valve seats after closing of the valve, angle α can be in the range from about 20 to about 35 degrees. It should be understood that no particular interior profile is required as long as the requirements of cutting on one side while releasing the conduit on the other side of the valve element is achieved.

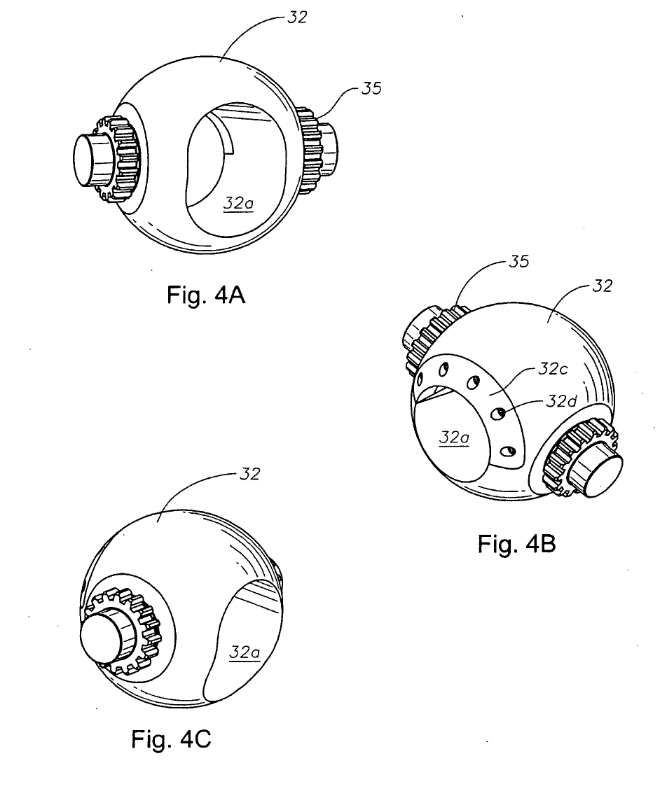

FIGS. 4A, 4B and 4C show isometric views of valve element 32. FIG. 4A is oriented from the direction of the enlarged end of channel 32a. Gears 35 or any suitable mechanical mechanism attached to element 32 may be used with an actuator to rotate valve element 32 around an axis of rotation, as will be shown below. A rack and pinion mechanism may be used, for example. Alternatively, any actuator and rotation driver arrangement may be used to operate valve element 32. FIG. 4B is oriented from the direction of minimum size of channel 32a, showing cutting segment 32c held in place by screws 32d. FIG. 4C shows another side view of element 32. Channel 32a is preferably formed perpendicular to the axis of rotation of the valve element.

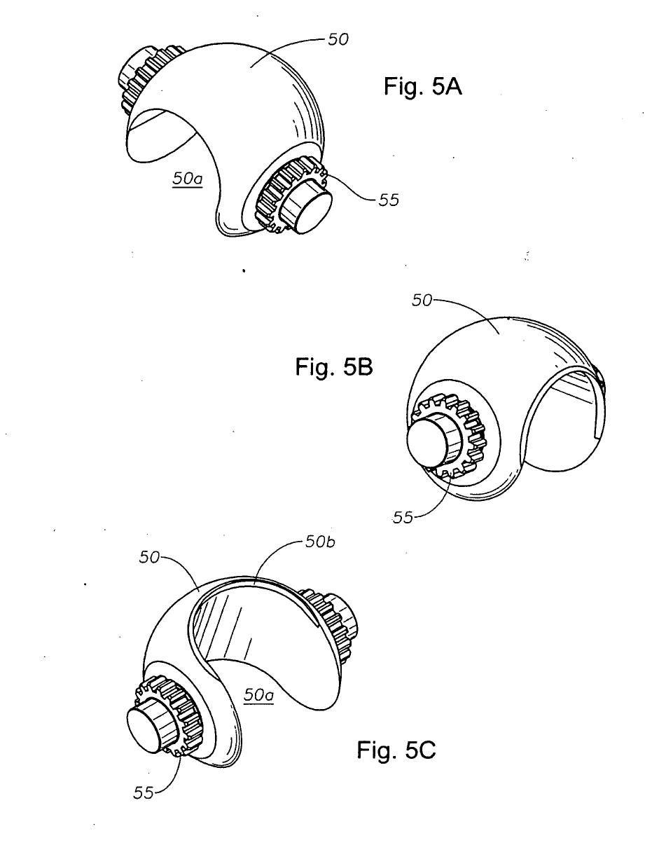

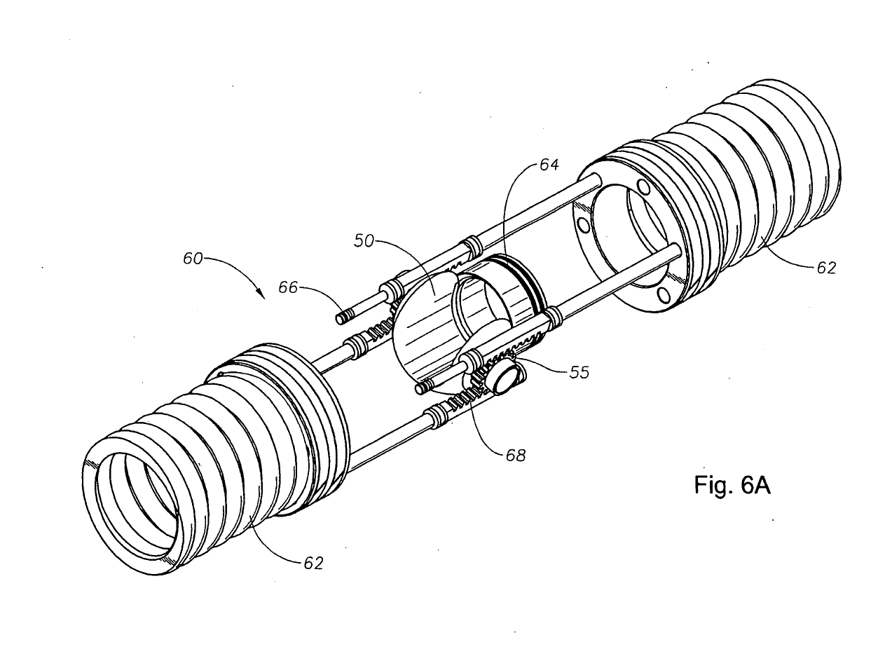

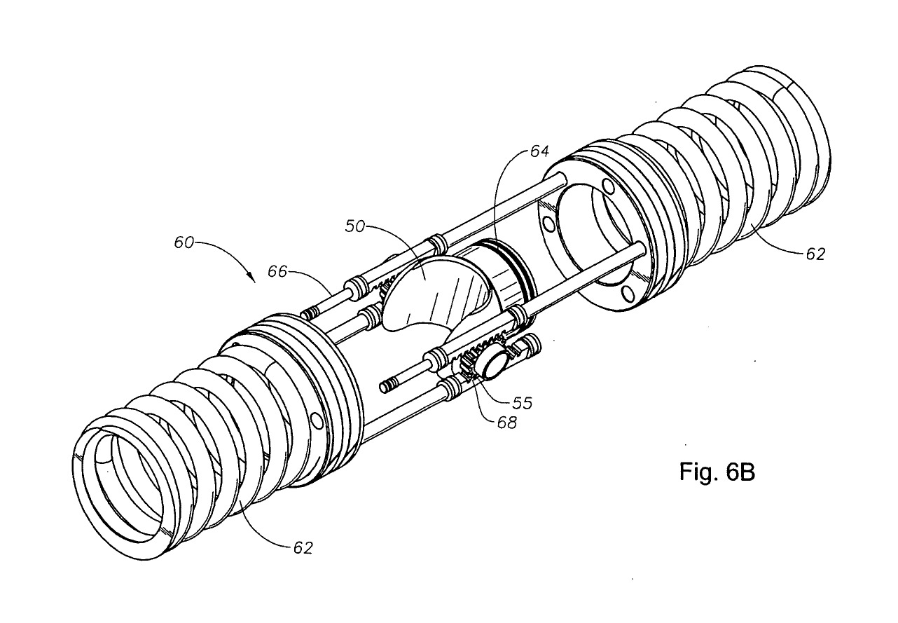

FIGS. 5A-5C illustrate another embodiment of a cutting valve element. Unlike conventional ball valves and the embodiment disclosed above, which close on two valve seats, this embodiment closes on only one valve seat. In this embodiment, valve element flow channel 50a is open to one side of the axis of rotation of the valve element—i.e., valve element 50 is U-shaped with a spherical outside sealing surface. Channel 50a is preferably formed perpendicular to the axis of rotation of the valve element. Since only one cut is made on a conduit in the valve, less force is required to operate the valve than with a conventional ball valve cutter. Therefore, a smaller actuator requiring less power may be used.

Referring to FIG. 5C, cutter valve element 50 may include cutting element 50b, which may be made of a hardened material, such as metal or ceramic, and may be replaceable with screws (not shown) or other joining method. The preferred cutter comprises a sharp knife-like edge at or near the end of the flow channel, but any shape or design capable of shearing through tubing or a line may be considered a cutter.

The disclosed cutting system may comprise apparatus for actuating the valve in response to a signal. Power for the actuator may come from the surface (hydraulic, pneumatic or electrical) or from energy stored downhole (spring or compressed gas). The signal may come from the surface or from a downhole sensor. FIGS. 6A and 6B illustrate actuator/spring mechanism 60, which may be used to operate a cutter valve element disclosed herein. The valve element of element of FIG. 5 is illustrated. Alternatively, a valve element such as illustrated in FIG. 3 and FIG. 4 may be used. The actuator of FIGS. 6A and 6B operates with a rack and pinion gear mechanism, but any type of actuator may be used that applies sufficient torque to operate a cutting valve element as disclosed herein.

FIGS. 6A and 6B illustrate valve element 50 in the open (FIG, 6A) and closed (FIG. 6B) positions when mounted in actuator/spring mechanism 60. Rack gear 68 is moved axially by movement of piston 66 to cause rotation of valve element 50, through pinion gear 55. Piston 66, which is located in a piston housing to be described below, is moved by application of hydraulic pressure, as described below. Valve element 50 seals on a valve seat (not shown) when in the closed position. Seals 64 allow the valve seat to be hydraulically connected to a housing. Alternatively, valve element 32 of FIG. 3 or FIG. 4 may be used and may seal on two valve seats. Springs 62 may be used for storing energy downhole to operate the valve element, in which case the springs may be held in compression by hydraulic pressure from the surface, for example, as illustrated in FIG. 6A. In FIG. 6B, hydraulic pressure has been released, piston 66 has moved down, and valve element 50 has closed.

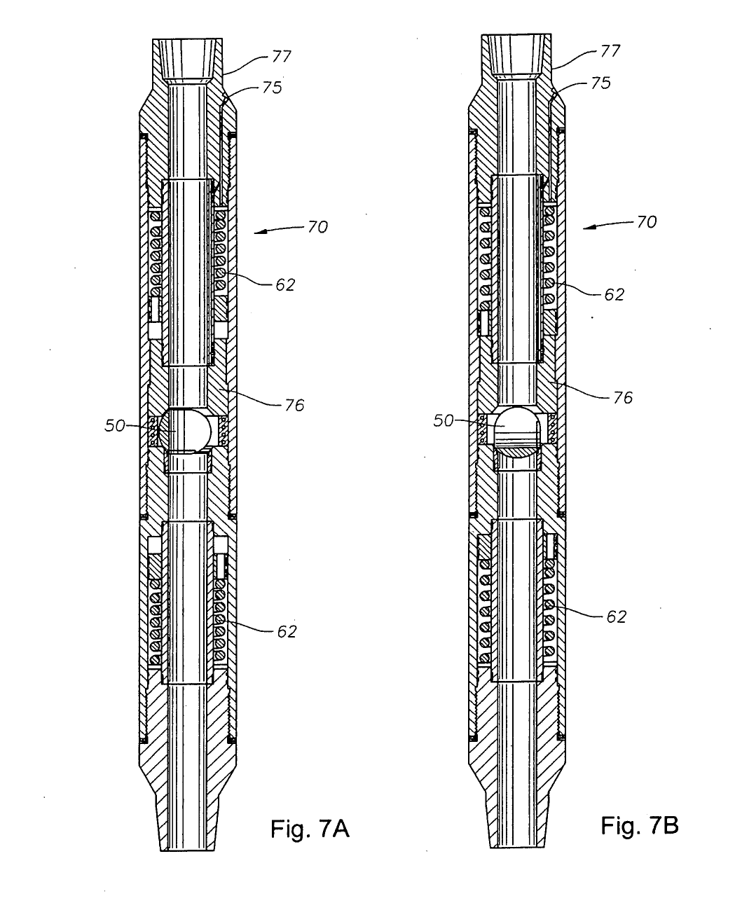

FIG. 7A shows downhole valve and cutter assembly 70, which includes the actuator spring mechanism shown in FIG. 6A, having springs 62 and cutter valve element 50, with the valve in the open position. Port 75 in body 77 may be joined to a remote hydraulic pressure source (not shown). Port 75 is hydraulically connected within body 77 to cylinders in piston housing 76 (not in plane of cross-section). Pistons 66 of FIG. 6 operate within the cylinders, such that application of hydraulic pressure at port 75 compresses springs 62 and holds cutter element 50 in the open position. When pressure from the pressure source is reduced, the springs are sized such that they supply sufficient torque to cut a conduit passing through the valve. Valve element 50 may be normally closed—i.e., hydraulic pressure must be applied to open the valve and compress springs 62. Because pressure must be applied to open valve element 50, the system will fail to the closed position and cut any conduit passing through the valve. Such a system is normally used in surface-controlled subsurface safety valves. Of course, the valve element may be normally open, in which case hydraulic pressure may be applied to close the valve, compress the springs and cut any conduit passing through the valve. In another embodiment, springs 62 may be replaced by or augmented with compressed gas in a cylinder.

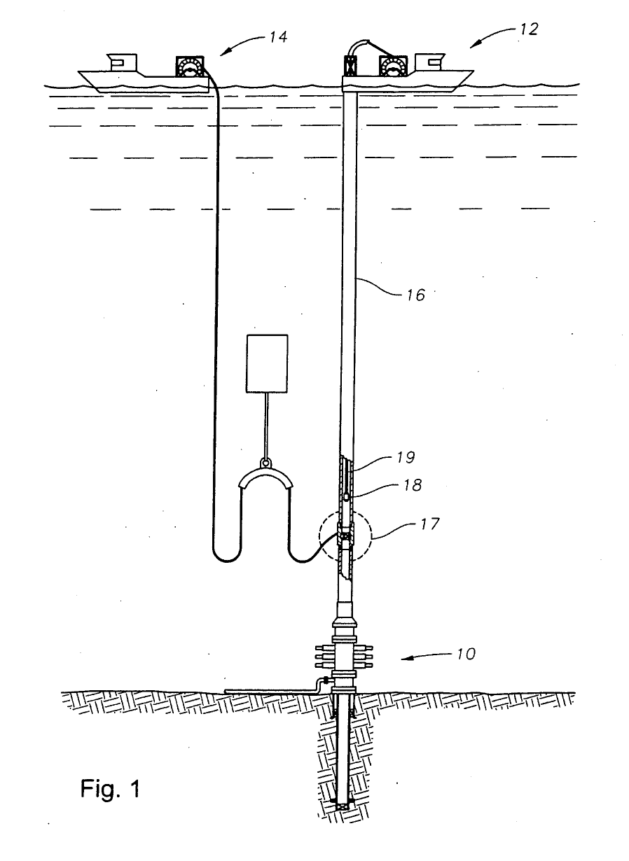

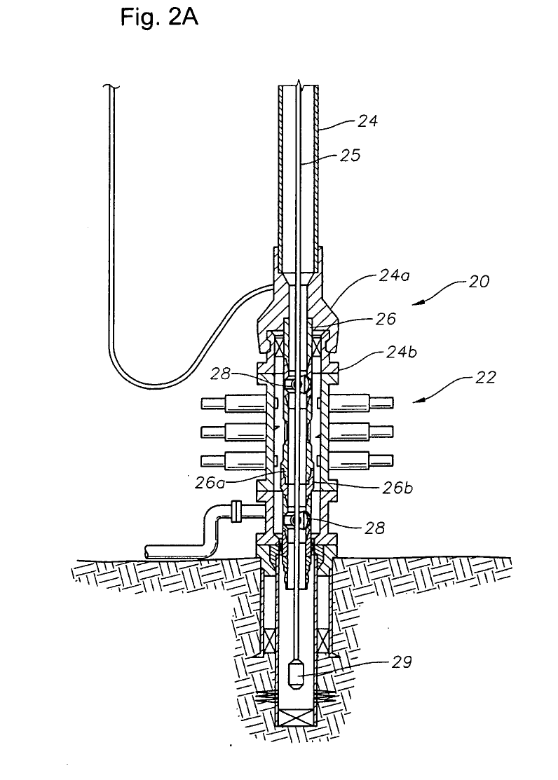

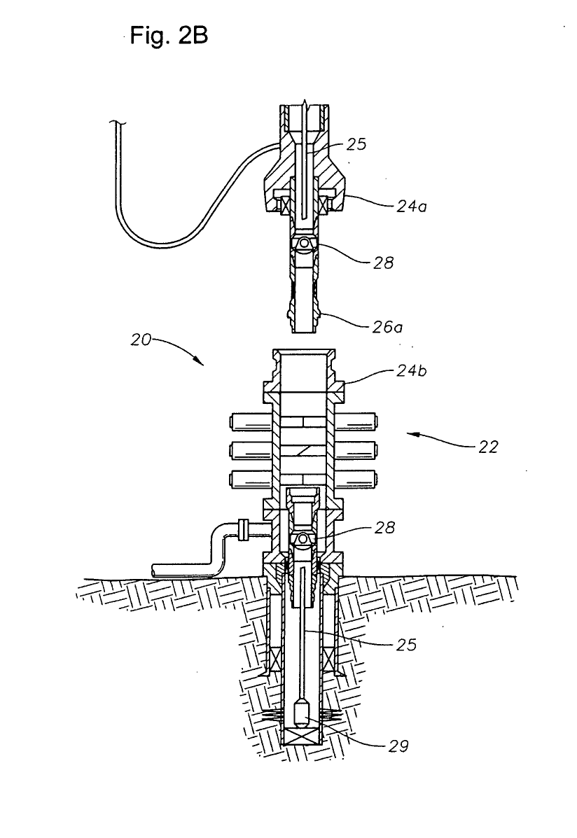

The cutter valve elements disclosed herein, valves including the cutter valve elements, and systems including the valves may be applied in intervention operations, such as illustrated in FIG. 1, where the valve is placed in a riser, in test trees placed in blowout preventers, such as illustrated in FIG. 2, in subsurface safety valves, where the valve is placed in tubing in a well instead of a riser, or in other tubular materials that may have a conduit passing through a valve when there is a need to close the valve before the conduit can be removed.

Although the present invention has been described with respect to specific details, it is not intended that such details should be regarded as limitations on the scope of the invention, except as and to the extent that they are included in the accompanying claims.

We claim:

1. A rotary valve having a body with a flow passage therethrough and a valve seat;
a cutting valve element having a spherical outside surface and an axis for rotary movement of the cutting valve element;
a channel through the cutting valve element perpendicular to the axis for rotary movement, the channel having a cutting edge on a first end of the channel and being sized to allow passage of a conduit having a selected diameter after the cutting edge has severed the conduit; and
a mechanism for rotating the cutting valve element in response to an actuator.

2. The valve element of claim 1 wherein the channel is formed from two intersecting openings having selected diameters and axes, the axes of the openings having a selected angle of intersection, so as to form a pair of sealing areas on the spherical outside surface.

3. The valve element of claim 1 wherein the channel is open on a first side of the axis for rotary motion of the cutting valve element and intersects the spherical outside surface on a second side of the axis for rotary movement, so as to form a single sealing area on the outside surface.

4. The valve element of claim 1 wherein the cutting edge is a part of a replaceable segment of the spherical outside surface.

5. The valve element of claim 2 wherein the angle of intersection of the openings is in the range from about 20 degrees and about 35 degrees.

6. A downhole apparatus for cutting a conduit passing through a valve and closing the valve in a subsea riser attached to a well or tubing in a well, comprising:
the valve of claim 1; and
an actuator for rotating the valve

7. The downhole apparatus of claim 6 wherein the actuator is powered by hydraulic pressure or compressed springs.

8. The downhole apparatus of claim 6 wherein the actuator includes a rack and pinion gear mechanism.

9. A subsea test tree, comprising:
the valve of claim 1; and
an actuator for rotating the valve.

10. The downhole apparatus of claim 9 wherein the actuator includes a rack and pinion gear mechanism.

11. A subsurface safety valve, comprising:
the valve of claim 1; and
an actuator for rotating the valve.
